(19) United States
(12) Patent Application Publication
(10) Pub. No.: US 2021/0010523 A1
(43) Pub. Date: Jan. 14, 2021

(54) CONNECTION STRUCTURE OF BOLT AND NUT HAVING DUMBELL-LIKE SHAPED ASYMMETRICAL BIDIRECTIONAL TAPERED THREAD

(71) Applicant: AMICUS VERITATIS MACHINERY CO., LTD., Taizhou (CN)

(72) Inventor: Yihua YOU, Taizhou (CN)

(21) Appl. No.: 17/037,526

(22) Filed: Sep. 29, 2020

Related U.S. Application Data
(63) Continuation of application No. PCT/CN2019/081400, filed on Apr. 4, 2019.

(30) Foreign Application Priority Data
Apr. 7, 2018 (CN) 201810303107.1

(51) Int. Cl. F16B 35/04

(52) U.S. Cl. CPC F16B 35/041

(57) ABSTRACT

The disclosure belongs to the field of general technology of device, and relates to a connection structure of a bolt and a nut having dumbbell-like shaped asymmetrical bidirectional tapered thread, which solves the problem of poor self-positioning and self-locking of existing threads. An internal thread (6) is a bidirectional tapered hole (41) (non-entity space) on an inner surface of, a cylindrical body (2), an external thread (9) is a bidirectional tapered cone body (71) (material entity) on an outer surface of a columnar body (3), and a complete unit thread is a helical dumbbell-like shaped asymmetrical bidirectional tapered body small in the middle and large in both ends and having a left taper (95) greater than and/or small than a right taper (96).

### CROSS-REFERENCE TO RELATED APPLICATIONS

This application is a continuation of International Patent Application No. PCT/CN2019/081400, filed on Apr. 4, 2019, entitled “Connection structure of bolt and nut having dumbell-like shaped asymmetrical bidirectional tapered thread,” which claims priority to China Patent Application No. 201810303107.1, filed on Apr. 7, 2018. The content of these identified applications are hereby incorporated by references.

### TECHNICAL FIELD

The disclosure belongs to the field of general technology of device, and more particularly, relates to a connection nut of a bolt and a nut having dumbbell-like shaped asymmetrical bidirectional tapered thread (hereinafter referred to as “bolt and nut having bidirectional tapered thread).

### BACKGROUND

The disclosure of thread has a profound impact on the progress of human society. Thread is one of the most basic industrial technologies. It is not a specific product, but a key generic technology in the industry. It has the technical performance that must be embodied by specific products as application carriers, and is widely applied in various industries. The existing thread technology has high standardization level, mature technical theory and long-term practical application. It is a fastening thread when used for fastening, a sealing thread when used for sealing, and a transmission thread when used for transmission. According to the thread terminology of national standards, “thread” refers to a tooth body with the same thread form and continuously raising along a helical line on a cylindrical or conical surface; and “tooth body” refers to a material entity between adjacent tooth sides. This is also the definition of thread under global consensus.

Modern threads began in 1841 with Whitworth thread in England. According to the theory of modern thread technology, the basic condition for self-locking of the thread is that an equivalent friction angle shall not be smaller than a helix angle. This is an understanding for the thread technology in modern thread based on a technical principle-“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, he put forward the famous law of inclined plane that the gravity of an object placed on the inclined plane in the direction of inclined plane is proportional to the sine of inclination angle. The inclined plane refers to a smooth plane inclined to a horizontal plane, a helix is the deformation of the “inclined plane”, and a thread is like the inclined plane wrapped outside a cylinder. The flatter the inclined plane is, the greater a mechanical benefit is (see FIG. 14) (Yang Jingshan, Wang Xiuya, “Discussion on the Principle of Screw”, “Research on Gauss Arithmetic”).

The “principle of inclined plane” of the modern thread is an inclined plane slider model (see FIG. 15) which is established based on the law of inclined plane. It is believed that the thread pair meets the requirements of self-locking when a thread rise angle is less than or equal to the equivalent friction angle under the condition of little change of static load and temperature. The thread rise angle (see FIG. 16), also known as thread lead, angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The disclosure of the wedge thread was inspired by the “wooden wedge”. Specifically, the wedge thread has a structure that a wedge-shaped inclined plane forming an angle of 25°-30° with the thread axis is located at the root of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY

Any technical theory has theoretical hypothesis background; and the thread is not an exception. With the development of science and technology, the damage to connection is not simple linear load, static or room temperature environment; and linear load, nonlinear load and even the superposition of the two cause more complex load damaging conditions and complex application conditions. Based on such recognition, the object of the disclosure is to provide a connection structure of, a bolt and a nut having asymmetrical bidirectional tapered thread with the advantages of reasonable design, simple structure, and excellent connection performance and locking performance with respect to the above problems.

To achieve the above object, the following technical solution is adopted in the disclosure: the bolt and nut having bidirectional tapered thread refers to a special thread pair technology combining technical characteristics of a cone pair and a helical movement, and a thread connection pair formed by an internal thread of an asymmetrical bidirectional tapered thread and an external thread of the asymmetrical bidirectional tapered internal thread is used. The bidirectional tapered body is composed of two single tapered bodies, i.e., bidirectionally composed of two single tapered bodies which have a left taper and a right taper opposite in directions and different in tapers. The bidirectional tapered body is helically distributed on an outer surface of the columnar body to form the external thread and/or the bidirectional tapered body is helically distributed on an inner surface of the cylindrical body to form the internal thread, and a complete unit thread of the thread is a dumbbell-like shaped special bidirectional tapered geometry small in the middle and large in both ends and having a left taper greater than a right taper and/or the left taper smaller than the right taper no matter the bidirectional tapered body is the internal thread or the external thread.

For the bolt and nut having bidirectional tapered thread, the dumbbell-like shaped asymmetrical bidirectional tapered thread comprises two forms that the left taper is greater than the right taper and the left taper is smaller than the right taper, the definition of which can be expressed as: “a dumbbell-like shaped special helical bidirectional tapered geometry on a cylindrical or conical, surface, which is small in the middle and large in, both ends and has the asymmetrical bidirectional tapered holes (or asymmetrical bidirectional truncated cone bodies) with the specified left and right tapers reverse or opposite in directions and different in tapers, and the asymmetrical bidirectional tapered holes (or asymmetrical bidirectional truncated cone bodies) are continuously and/or discontinuously distributed along the helical line”. The head or the tail of the asymmetrical bidirectional tapered thread may be an incomplete bidirectional tapered geometry due to manufacturing and other reasons. The mutual fit between threads has changed from the engagement relationship between the internal thread and the external thread of modern threads to the cohesion relationship between the internal thread and the external thread in the bidirectional tapered thread.

The bolt and nut having bidirectional tapered thread comprises a bidirectional truncated cone body helically distributed on an outer surface of a columnar body, and a bidirectional tapered hole helically distributed on an inner surface of a cylindrical body, i.e., comprises an external thread and an internal thread in mutual thread fit, wherein the internal thread is presented by the helical bidirectional tapered hole and exists in a form of a “non-entity space”, while the external thread is presented by the helical bidirectional truncated cone body and exists in a form of a “material entity”. The non-entity space refers to a space environment capable of accommodating the above material entity. The internal thread is a containing part; and the external thread is a contained part. The internal thread (i.e., the bidirectional tapered hole) and the external thread (i.e., the bidirectional truncated cone body) are sleeved together by screwing bidirectional tapered geometries in pitches, and the internal thread is cohered with the external thread until one side bears the load bidirectionally or the left side and the right side bear the load bidirectionally at the same time or till interference fit. Whether the two sides bear bidirectional load at the same time is related to the actual working conditions in the application field, and the bidirectional tapered hole contains and is cohered with the bidirectional truncated cone body in pitches i.e., the internal thread is cohered with the corresponding external thread in, pitches.

The thread connection pair is a thread pair formed by fitting a helical outer conical surface with a helical inner conical surface to form a cone pair. An, outer conical surface of an external cone body of the bidirectional tapered thread is a bidirectional conical surface. When the thread connection pair is formed between the bidirectional tapered external thread and a traditional internal thread, a joint surface between a special conical surface of the traditional internal thread and the outer conical surface of the bidirectional tapered external thread is used as a bearing surface, i.e., the conical surface is used as the bearing surface to realize the technical performance of connection. The self-locking, self-positioning, reusability, fatigue resistance and other capabilities of the thread pair mainly depend on size of the conical surfaces forming the cone pair of the connection structure of the bolt and the nut having bidirectional tapered thread as well as size of the conical surfaces thereof, i.e., sizes of the conical surfaces of the internal and external threads as well as tapers thereof, and the thread connection pair is a non-toothed thread.

Different from that the principle of inclined plane of the existing thread which shows a unidirectional force distributed on the inclined plane as well as an engagement relationship between the internal tooth bodies and the external tooth bodies, the thread, body of the bolt and nut having bidirectional tapered thread, i.e., the bidirectional tapered body is composed of two plain lines of the cone body in two directions (i.e. bidirectional state) when viewed from any cross section of the single cone body distributed on either left or right side along the cone axis. The plain line is the intersection line of the conical surfaces and a plane through which the cone axis passes. The cone principle of the connection structure of the bolt and the nut having asymmetrical bidirectional tapered thread shows an axial force and a counter-axial force, both of which are combined by bidirectional forces, wherein the axial force and the corresponding counter-axial force are opposite to each other. The internal thread and the external thread are in a cohesion relationship. Namely, the connection pair is formed by cohering the external thread with the internal thread, i.e., the tapered hole (internal cone) is cohered with the corresponding cone body (external cone body) pitch by pitch till the self-positioning is realized by cohesion fit or till the self-locking is realized by interference contact. Namely, the self-locking or self-positioning of the internal cone body and the external cone body is realized by radially cohering the special tapered hole and the truncated cone body to realize the self-locking or self-positioning of the thread pair, rather than the thread connection pair, composed of the internal thread and the external thread in the traditional thread, which realizes a thread connection performance by mutual abutment between the tooth bodies.

A self-locking force will arise when the cohesion process between the internal thread and the external thread reaches certain conditions. The self-locking force is generated by a pressure produced between an axial force of the internal cone and a counter-axial force of the external cone. Namely, when the internal cone and the external cone form the cone pair, the inner conical surface of the internal cone body is cohered with the outer conical surface of the external cone body; and the inner conical surface is in close contact with the outer conical surface. The axial force of the internal cone and the counter-axial force of the external cone are concepts of forces unique to the bidirectional tapered thread technology, i.e., the cone pair technology, in the disclosure.

The internal cone body exists in a form similar to a shaft sleeve, and generates the axial force pointing to or pressing toward the cone axis under the action of external load. The axial force is bidirectionally combined by a pair of centripetal forces which are distributed in mirror image with the cone axis as a center and are respectively perpendicular to two plain lines of the cone body: i.e., the axial force passes through the cross section of the cone axis and is composed of two centripetal forces which are bidirectionally distributed on two sides of the cone axis in mirror image with the cone axis being the center, are respectively perpendicular to the two plain lines of the cone body, and point to or press toward a common point of the cone axis; and the axial force passes through, a cross section of a thread axis and is composed of two centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The axial force is densely distributed on the cone axis and/or the thread axis in an axial and circumferential manner, and corresponds to an axial force angle, wherein the axial force angle is formed by an angle between two centripetal forces forming the axial force and depends on the taper of the cone body, i.e., the taper angle.

The external cone body exists in a form similar to a shaft, has relatively strong, ability to absorb various external loads, and generates a counter-axial force opposite to each axial force of the internal cone body. The counter-axial force is bidirectionally combined by a pair of counter-centripetal forces which are distributed in mirror image with the cone axis as the center and are respectively perpendicular to the two plain lines of the cone body; i.e., the counter-axial force, passes through the cross section of the cone axis and is composed of two counter-centripetal forces which are bidirectionally distributed on two sides of the cone axis in mirror image with the cone axis as the center, are respectively perpendicular to the two plain lines of the cone body, and point to or press toward the common point of the cone axis; and the counter-axial force passes through the cross section of the thread axis and is composed of two counter-centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The counter-axial force is densely distributed on the cone axis and/or the thread axis in the axial and circumferential manner, and corresponds to a counter-axial force angle, wherein the counter-axial force angle is formed by an angle between the two counter-centripetal forces forming the counter-axial, force and depends on the taper of the cone body, i.e., the taper angle.

The axial force and the counter-axial force start to be generated when the internal cone and the external cone of the cone pair are in effective contact, i.e., a pair of corresponding and opposite axial force and counter-axial force always exist during the effective contact of the internal cone and the external cone of the cone pair. The axial force and the counter-axial force are bidirectional forces bidirectionally distributed in mirror image with the cone axis and/or the thread axis as the center, rather than unidirectional forces. The cone axis and the thread axis are coincident axes, i.e., the same axis and/or approximately the same axis. The counter-axial force and the axial force are reversely collinear and are reversely collinear and/or approximately reversely collinear when the cone body and the helical structure are combined into the thread and form the thread pair. The internal cone and the external cone are cohered till interference is achieved, so the axial force and the counter-axial force generate a pressure on the contact surface between the inner conical surface and the outer conical surface and are densely and uniformly distributed on the contact surface between the inner conical surface and the outer conical surface axially and circumferentially. When the cohesion movement of the internal cone and the external cone continues till the cone pair reaches the pressure generated by interference fit to combine the internal cone with the external cone, i.e., the pressure enables the internal cone body to be cohered with the external cone body to form a similar integral structure and will not cause the internal cone body and the external cone body to separate from each other under the action of gravity due to arbitrary changes in, a direction of a body position of the similar integral structure after the external force caused by the pressure disappears. The cone pair generates self-locking, which means that the thread pair generates self-locking. The self-locking performance has a certain degree of resistance to other external loads which may cause the internal cone body and the external cone body to separate from each other except gravity. The cone pair also has the self-positioning performance which enables the internal cone and the external cone to be fitted with each other. However, not any axial force angle and/or counter-axial force angle may enable the cone pair to generate self-locking and self-positioning.

When the axial force angle and/or the counter-axial force angle is less than 180° and greater than 127°, the cone pair has the self-locking performance. When the axial force angle and/or the counter-axial force angle is infinitely close to 180°, the cone pair has the best self-locking performance and the weakest axial bearing capacity. When the axial force angle and/or the counter-axial force angle is equal to and/or less than 127° and greater than 0°, the cone pair is in a range of weak self-locking performance and/or no self-locking performance. When the axial force angle and/or the counter-axial force angle tends to change in a direction infinitely close to 0°, the self-locking performance of the cone pair changes in a direction of attenuation till the cone pair completely has no self-locking ability; and the axial bearing capacity changes in a direction of enhancement till the axial bearing capacity is the strongest.

When the axial force angle and/or the counter-axial force angle is less than 180° and greater than 127°, the cone pair is in a strong self-positioning state, and the strong self-positioning of the internal cone body and the external cone body is easily achieved. When the axial force angle and/or the counter-axial force angle is infinitely close to 180°, the internal cone body and the external cone body of the cone pair have the strongest self-positioning ability. When the axial force angle and/or the counter-axial force angle is equal to and/or less than 127° and greater than 0°, the cone pair is in a weak self-positioning state. When the axial force angle and/or the counter-axial force angle tends to change in the direction infinitely close to 0°, the mutual self-positioning ability of the internal and external cone bodies of the cone pair changes in the direction of attenuation till the cone pair is close to have has no self-positioning ability at all.

Comparing the bidirectional tapered thread connection pair with the containing and contained relationship of irreversible one-sided bidirectional containment that the unidirectional tapered thread of single tapered body invented by the applicant before which can only bear the load by one side of the conical surface, the reversible left and right-sided bidirectional containment of the bidirectional tapered threads of double tapered bodies enables the left side and/or the right side of the conical surface to bear the load, and/or the left conical surface and the right conical surface to respectively bear the load, and/or the left conical surface and the right conical surface to simultaneously bear the load bidirectionally, and further limits a disordered degree of freedom between the tapered hole and the truncated cone body; and a helical movement enables the connection structure of the bolt and the nut having bidirectional tapered thread to obtain a necessary ordered degree of freedom, thereby effectively combining the technical characteristics of the cone pair and the thread pair to form a brand-new thread, technology.

When the connection structure of the bolt and the nut having bidirectional tapered thread is used, the conical surface of the bidirectional truncated cone body of the external thread of the bidirectional tapered thread is in mutual fit with the conical surface of the bidirectional tapered hole of the internal thread in the bidirectional tapered thread.

The self-locking and/or self-positioning of the thread connection pair is not realized at any taper or any taper angle of the truncated cone body and/or the tapered hole, i.e., the bidirectional tapered body forming the cone pair of the connection structure of the bolt and the nut having bidirectional tapered thread. The connection structure of the bolt and the nut having bidirectional tapered thread has the self-locking and self-positioning performances only if the internal and external cone body of the bidirectional tapered body reaches a certain taper or a certain taper angle. The taper comprises the left taper and the right taper of the internal and external threads. The right taper corresponds to the right taper angle, i.e., a second taper angle α2. When the left taper is greater than the right taper, the first taper angle α1 is greater than 0° and smaller than 53′; and preferably, the first taper angle α1 is 2°-40°. In individual special fields, it is preferable that the first taper angle α1 is greater than or equal to 53° and smaller than 180°; and preferably, the first taper angle α1 is 53°-90°. It is preferable that the second taper angle α2 is greater than 0° and smaller than 53°; and preferably, the second taper angle α2 is 2°-40°.

When the left taper is smaller than the right taper, it is preferable that the first taper angle α1 is greater than 0° and smaller than 53°; and preferably, the first taper angle α1 is 2°-40°. It is preferable that the second taper angle α2 is greater than 0° and smaller than 53°; and preferably, the second taper angle α2 is 2″−40°. In individual special fields, it is preferable that the second taper angle α2 is greater than or equal to 53° and smaller than 180°; and preferably, the second taper angle α2 is 53°-90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

According to the bolt and nut having bidirectional tapered thread, the external thread is arranged on the outer surface of the columnar body to form a bolt, wherein the columnar body is provided with a screw body, and a truncated cone body is helically distributed on an outer surface of the screw body. The truncated cone body comprises an asymmetrical bidirectional truncated cone body. The columnar body may be solid or hollow, comprising cylindrical and/or non-cylindrical workpieces and objects that need to be machined with threads on outer surfaces thereof, and comprising outer surfaces such as cylindrical surfaces, non-cylindrical surfaces such as conical surfaces, and the like.

According to the bolt and nut having bidirectional tapered thread, the asymmetrical bidirectional truncated cone body, i.e., the external thread is formed by oppositely jointing two asymmetrical upper sides of two truncated cone bodies, wherein the two truncated cone bodies have same lower sides and upper sides, but different cone, heights, and the lower sides of the two truncated cone bodies are located at two ends of the bidirectional truncated cone body and are mutually jointed with the lower sides of the adjacent bidirectional truncated cone body and/or to be mutually jointed with the lower sides of the adjacent bidirectional truncated cone body. The external thread comprises a first helical conical surface of the truncated cone body, a second helical conical surface of the truncated cone body and an external helical line. In a cross section through which the thread axis passes, the complete single-pitch asymmetrical bidirectional tapered external thread is a dumbbell-like shaped special bidirectional tapered geometry small in the middle and large in both ends. The asymmetrical bidirectional truncated cone body comprises a conical surface of the bidirectional truncated cone body. An angle formed between two plain lines of a left conical surface of the bidirectional truncated cone body, i.e., the first helical conical surface of the truncated cone body, is the first taper angle α1. The left taper is formed on the first helical conical surface of the truncated cone body and is subjected to a right-direction distribution. An angle formed between two plain lines of a right conical surface of the asymmetrical bidirectional truncated cone body, i.e., the second helical conical surface of the truncated cone body, is the second taper angle α1. The right taper is formed on the second helical conical surface of the truncated cone body and is subjected to a left-direction distribution. The taper directions corresponding to the first taper angle α1 and the second taper angle α2 are opposite. The plain line is an, intersection line of the conical surface and the plane through which the cone axis passes. A shape formed by the first helical conical surface of the truncated cone body and the second helical conical surface of the truncated cone body of the bidirectional truncated cone body is the same as a shape of a helical outer flank of a rotating body, wherein the rotating body is formed by two hypotenuses of a right-angled trapezoid union being rotated around a right-angled side of the right-angled trapezoid union, and, at the same time, the right-angled trapezoid union axially moves at a constant speed along a central axis of the columnar body; wherein the right-angled trapezoid union refers to a special geometry formed by oppositely jointing two asymmetrical upper sides of two right-angled trapezoids, the two right-angled trapezoids have same lower sides and upper sides, but different right-angled sides, and the lower sides of the two right-angled trapezoids are respectively located at two ends of the right-angled trapezoid union; and the two right-trapezoids are coincident with the central axis of the columnar body.

According to the bolt and nut having bidirectional tapered thread, the internal thread is arranged on the inner surface of the cylindrical body to form a nut, wherein the cylindrical body is provided with a nut body, and a tapered hole is helically distributed on the inner surface of the cylindrical body. The tapered hole comprises an asymmetrical bidirectional tapered hole. The cylindrical body comprises cylindrical and/or non-cylindrical workpieces and objects that need to be machined with internal threads on inner surfaces thereof, wherein the inner surfaces comprise geometric shapes of inner surfaces such as cylindrical surfaces, non-cylindrical surfaces such as conical surfaces and the like.

According to the bolt and nut having bidirectional tapered thread, the asymmetrical bidirectional, tapered hole, i.e., the internal thread is formed by oppositely jointing two asymmetrical upper sides of two tapered holes, wherein the two tapered holes have same lower sides and upper sides but different cone heights, and the lower sides of the two tapered holes are located at two ends of the bidirectional tapered hole and are mutually jointed with the lower sides of the adjacent bidirectional tapered hole and/or to be mutually jointed with the lower sides of the adjacent bidirectional tapered hole. The internal thread comprises a first helical conical surface of the tapered hole, a second helical conical surface of the tapered hole and an internal helical line. In a cross section through which the thread axis passes, the complete single-pitch asymmetrical bidirectional tapered internal thread is a dumbbell-like shaped special bidirectional tapered geometry small in the middle and large in both ends. The asymmetrical bidirectional tapered hole comprises a conical surface of the bidirectional tapered hole. An angle formed between two plain lines of a left conical surface of the bidirectional tapered hole, i.e., the first helical conical surface of the tapered hole, is the first taper angle α1. The left taper is formed on the first helical conical surface of the tapered hole and is subjected to aright-direction distribution. An angle formed between two plain lines of a right conical surface of the bidirectional tapered hole, i.e., the second helical conical surface of the tapered hole, is the second taper angle α2. The right taper is formed on the second helical conical surface of the tapered hole and is subjected to a left-direction distribution. The taper directions corresponding to the first taper angle α1 and the second taper angle α2 are opposite. The plain line is an intersection line of the conical surface and the plane through which the cone axis passes. A shape formed by the first helical conical surface of the tapered hole and the second helical conical surface of the tapered hole of the bidirectional tapered hole is the same as a shape of a helical outer flank of a rotating body wherein the rotating body is formed by two hypotenuses of a right-angled trapezoid union being rotated around a right-angled side of the right-angled trapezoid union, and, at the same time, the right-angled trapezoid union axially moves at a constant speed along a central axis of the cylindrical body; wherein the right-angled trapezoid union refers to a special geometry formed by oppositely jointing, two asymmetrical upper sides of two right-angled trapezoids, the two right-angled trapezoids have same lower sides and upper sides, but different right-angled sides and the lower sides of the two right-angled trapezoids are respectively located at two ends of the right-angled trapezoid union; and the two right-trapezoids are coincident with the central axis of the cylindrical body.

When the connection structure of the bolt and the nut having bidirectional tapered thread is working, relationships between the connection structure and the workpiece comprises rigid connection and non-rigid connection. The rigid connection means that a nut bearing surface and a workpiece bearing surface are mutually bearing surfaces, comprising structural forms like single nut and double nuts, etc. The non-rigid connection means that opposite side end surfaces of two nuts are mutually bearing surfaces and/or the opposite side end surfaces of the two nuts are mutually bearing surfaces indirectly if a gasket is provided therebetween. The non-rigid connection is mainly applied to non-rigid materials or non-rigid connection workpieces such as transmission pieces and other application fields that need to be installed through double nuts to satisfy requirements, etc. The workpieces refer to connected objects comprising the workpieces, and the gasket refers to a gasket-comprising spacer.

According to the bolt and nut having bidirectional tapered thread, when a connection structure of a bolt and double nuts is adopted and a relationship with the fastened workpiece is rigid connection, working bearing surfaces of the thread are different. When the cylindrical body is located at a left side of the fastened workpiece i.e., a left end surface of the fastened workpiece, and a right end surface of the cylindrical body (i.e., the left nut body) is the locking bearing surface between the left nut body and the fastened workpiece, the left helical conical surfaces of the bidirectional tapered threads of the left nut body and the columnar body (i.e., the screw body), i.e., the bolt, are the tapered thread bearing surfaces, namely, the first helical conical surface of the tapered hole and the first helical conical surface of the truncated cone body are the tapered thread bearing surfaces, and the first helical conical surface of the tapered hole and the first helical conical surface of the truncated cone body are mutually bearing surfaces. When the cylindrical body is located at a right side of the fastened workpiece, i.e., a right end surface of the fastened workpiece, and a left end surface of the cylindrical body (i.e., the right nut body) is the locking bearing surface between the right nut body and the fastened workpiece, the right, helical conical surfaces of the bidirectional tapered threads of the right nut body and the columnar body (i.e., the screw body), the bolt, are the tapered thread bearing surfaces, namely, the second helical conical surface of the tapered hole and the second helical conical surface of the truncated cone body are the tapered thread bearing surfaces, and the second helical conical surface of the tapered hole and the second helical conical surface of the truncatcd cone body are mutually bearing surfaces.

According to the bolt and nut having bidirectional tapered thread, when a connection structure of a bolt and a single nut is adopted and the relationship with the fastened workpiece is rigid connection, and when a hexagon head of the bolt is located at a left side, the cylindrical body (i.e., the nut body), i.e., the single nut is located at a right side of the fastened workpiece. When the connection structure of the bolt and the single nut is working, a right end surface of the workpiece and a left end surface of the nut body are locking bearing surfaces between the nut body and the fastened workpiece, the right helical conical surfaces of the bidirectional tapered threads of the nut body and the columnar body (i.e., the screw body), i.e., the bolt, are the tapered thread bearing surfaces. Namely, the second helical conical surface of the tapered hole and the second helical conical surface of the truncated cone body are the tapered thread bearing surfaces, and the second helical conical surface of the tapered hole and the second helical conical surface of the truncated cone body are mutually bearing surfaces. When the hexagon head of the bolt is located at a right side, the cylindrical body (i.e., nut body), i.e., the single nut is located at a left side of the fastened workpiece. When the connection structure of the bolt and the single nut is working, a left end surface of the workpiece and a right end surface of the nut body are locking bearing surfaces between the nut body and the fastened workpiece, the left helical, conical surfaces of the bidirectional tapered threads of the nut body and the columnar body (i.e., the screw body), i.e., the bolt, are the tapered thread bearing surfaces. Namely, the first helical conical surface of the tapered hole and the first helical conical surface of the truncated cone body are the tapered thread bearing surfaces, and the first helical conical surface of the tapered hole and the first helical conical surface of the truncated cone body are mutually bearing surfaces.

According to the bolt and nut having bidirectional tapered thread, when a connection structure of a bolt and double nuts is adopted and the relationship with the fastened workpiece is non-rigid connection, working bearing surfaces of the thread are different. Namely, the tapered thread bearing surfaces are different. The cylindrical body comprises a left nut body and a right nut body. A right end surface of the left nut body and a left end surface of the right nut body are oppositely and directly contacted, and are mutually locking bearing surfaces. When the right end surface of the left nut body is the locking bearing surface, the left helical conical surfaces of the bidirectional tapered threads of the left nut body and the columnar body (i.e., the screw body), i.e., the bolt, are the tapered thread bearing surfaces. Namely, the first helical conical surface of the tapered hole and the first helical conical surface of the truncated cone body are the tapered thread bearing surfaces, and the first helical conical surface of the tapered hole and the first helical conical surface of the truncated cone body are mutually bearing surfaces. When the left end surface of the right nut body is the locking bearing surface, the right helical conical surfaces of the bidirectional tapered threads of the right nut body and the columnar body (i.e., the screw body), i.e., the bolt, are the tapered thread bearing surfaces. Namely, the second helical conical surface of the tapered hole and the second helical conical surface of the truncated cone body are the tapered thread bearing surfaces, and the second helical conical surface of the tapered hole and the second helical conical surface of the truncated cone body are mutually bearing surfaces.

According to the bolt and nut having bidirectional tapered thread, when a connection structure of a bolt and double nuts is adopted and the relationship with the fastened workpiece is non-rigid connection, working bearing surfaces of the thread are different. The cylindrical body comprises two cylindrical bodies, i.e., a left nut body and aright nut body. Namely, a spacer like a gasket is arranged between the left nut body and the right nut body. A right end surface of the left nut body and a left end surface of the right nut body are oppositely and indirectly contacted via the gasket, and thus serve as mutually locking bearing surfaces indirectly. When the cylindrical body is located at a left side of the gasket, i.e., a left surface of the gasket, and the right end surface of the left nut body is the locking bearing surface of the left nut body, the left helical conical surfaces of the bidirectional tapered threads of the left nut body and the columnar body (i.e., the screw body), i.e., the bolt, are the tapered thread bearing surfaces. Namely, the first helical conical surface of the tapered hole and the first helical conical surface of the truncated cone, body are the tapered thread bearing surfaces, and the first helical conical surface of the tapered hole and the first helical conical surface of the truncated cone body are mutually bearing surfaces. When the cylindrical body is located at a right side of the gasket, i.e., a right surface of the gasket, and the left end surface of the right nut body is the locking bearing surface of the right nut body, the right helical conical surfaces of the bidirectional tapered threads of the right nut body and the columnar body (i.e., the screw body), i.e., the bolt, are the tapered thread bearing surfaces. Namely, the second helical conical surface of the tapered hole and the second helical conical surface of the truncated cone body are the tapered thread bearing surface, and the second helical conical surface of the tapered hole and the second helical conical surface of the truncated cone body are mutually bearing surfaces.

According to the bolt and nut having bidirectional tapered thread, when a connection structure of a bolt and double nuts is adopted and the relationship with the fastened workpiece is non-rigid connection, when the cylindrical body located inside, i.e., the nut body adjacent with the fastened workpiece is already effectively combined together with the columnar body (i.e., the screw body), i.e., the bolt, namely, the internal thread and the external thread forming the tapered thread connection pair are effectively cohered together, the cylindrical body located outside, i.e., the nut body not adjacent with the fastened workpiece may keep an original situation and/or be dismounted with one nut (for example, such application fields having lightweight requirements on equipment or not needing double nuts to ensure the reliability of the connection technology) according to application conditions. The dismounted nut body is not used as a connection nut, but only used as an installation process nut. An internal thread of the installation process nut is not only manufactured by traditional tapered threads comprising but being not limited to triangular threads, trapezoidal threads sawtooth threads and other traditional threads, and may also be a nut body made of bidirectional tapered threads and unidirectional tapered threads and other threads that can be screwed with the bolt threads. On the premise of ensuring the reliability of the connection technology, the tapered thread connection pair is a closed-loop fastening technical system, namely, after the internal thread and the external thread of the tapered thread connection pair are effectively cohered together, the tapered thread connection pair will become an independent technical system without relying on technical compensations from a third party to ensure the technical effectiveness of the connection technical system. In other words, the effectiveness of the tapered thread connection pair will not be affected even without the support of other objects and even if there is a gap between the tapered thread connection pair and the fastened workpiece. This will greatly reduce the weight of the equipment, remove invalid loads, and improve the technical requirements on an effective loading capability, braking performance, and energy conservation and emission reduction of the equipment, which is a unique thread technical advantage no matter the relationship between the tapered thread connection pair of the connection structure of the bolt and the nut having bidirectional tapered thread and the fastened workpiece is non-rigid connection or rigid connection, and is not possessed by other thread technologies.

During transmission connection of the bolt and nut having bidirectional tapered thread, bidirectional bearing is implemented through screwing connection of the bidirectional tapered hole and the bidirectional truncated cone body. When the external thread and the internal thread forms the thread pair, a clearance between the bidirectional truncated cone body and the bidirectional tapered hole is required. If oil and other media are lubricated between the internal thread and the external thread, a bearing oil film will be easily formed, and the clearance is beneficial to the formation of the bearing oil film. The application of the bolt and the nut having bidirectional tapered thread in transmission connection is equivalent to a pair of sliding bearings consisting of one pair and/or several pairs of sliding bearings, namely, each pitch of the traditional internal thread bidirectionally contains a corresponding pitch of traditional external thread to, form a pair of sliding bearings. A number of the formed sliding bearings is adjusted according to the application conditions, namely, a pitch number of containing and contained threads cohered by the effectively bidirectional jointing, i.e., effectively bidirectional contact of the traditional internal thread and the bidirectional tapered external thread is designed according to application conditions. Through the containment of the truncated cone body by the bidirectional tapered hole, by virtue of positioning in multiple directions such as radial, axial, angular and circumferential, and preferably through the containment of the bidirectional truncated cone body by the bidirectional tapered hole and the main positioning in the radial and circumferential directions supplemented by the auxiliary positioning in the axial and angular directions, so as, to form multidirectional positioning of the internal and external cone bodies, till the conical surface of the bidirectional tapered hole is cohered with the conical surface of the bidirectional truncated cone body to implement self-positioning or till self-locking is generated by interference fit, a special combining technology of the cone pair and the thread pair is constituted, which ensures the precision, efficiency and reliability of the transmission connection of the tapered thread technology and especially the connection structure of the bolt and the nut having bidirectional tapered thread.

When the bolt and nut having bidirectional tapered thread is tightly connected and hermetically connected, technical performances thereof are realized through the screwing connection of the bidirectional tapered hole and the bidirectional truncated cone body, namely, the technical performances are realized through sizing of the first helical conical surface of the truncated cone body and the special conical surface of the special tapered hole till interference and/or sizing of the second helical conical surface of the truncated cone body and the second helical conical surface of the tapered hole till interference. According to application conditions, one direction bears the load and/or two directions simultaneously bear the load respectively. Namely, under the guidance of the helical line, an outer diameter of an internal cone of the bidirectional truncated cone body and an inner diameter of an, external cone of the bidirectional tapered hole are centered till the first helical conical surface of the tapered hole is cohered with the first helical conical surface of the truncated cone body till one direction bears the load and/or two directions simultaneously bear the load respectively or till interference contact. In other words, through the containment of the bidirectional external cone body by the bidirectional internal cone body, by virtue of positioning in multiple directions such as radial, axial, angular and circumferential, and preferably through the containment of the bidirectional truncated cone body by the bidirectional tapered hole and the main positioning in the radial and circumferential directions supplemented by the auxiliary positioning in the axial and angular directions, so as to form multidirectional positioning of the internal and external cone, bodies, till the special conical surface of the bidirectional tapered hole is cohered with the conical surface of the bidirectional truncated cone body to implement self-positioning or till self-locking is generated by interference fit, a special combining technology of the cone pair and the thread pair is constituted, which ensures the efficiency and reliability of the tapered thread technology and especially the bolt and nut having bidirectional tapered thread, thus realizing technical performances such as connection, locking, anti-loosening, bearing, fatigue and sealing of mechanical structures.

Therefore, the technical performances such as the transmission precision and efficiency, the load bearing capacity, the locking force of self-locking, the anti-loosening ability, the sealing performance and the reusability of the bolt and nut having bidirectional tapered thread are related to the sizes of the first helical conical surface of the truncated cone body and the formed left taper, i.e., the first taper angle α1, and the second helical conical surface of the truncated cone body and the formed right taper, i.e., the second taper angle α2, as well as the sizes of the first helical conical surface of the tapered hole and the formed left taper, i.e., the first taper angle α1, and the second helical conical surface of the tapered hole and the formed right taper, i.e., the second taper angle α2. Material friction coefficient, processing quality and application conditions of the columnar body and the cylindrical body also have a certain impact on the cone fit.

In the bolt and nut having bidirectional tapered thread, when the right-angled trapezoid union rotates a circle at a constant speed, an axial movement distance of the right-angled trapezoid union is at least double a length of the sum of the right-angled sides of the two right-angled trapezoids, wherein the two right-angled trapezoids have same lower sides and upper sides, but different right-angled sides. This structure ensures that the first helical conical surface of the truncated cone body and the second helical conical surface of the truncated cone body as well as the first helical conical surface of the tapered hole and the second helical conical surface of the tapered hole have sufficient length, thus ensuring sufficient effective contact area and intensity when the conical surface of the bidirectional truncated cone body is fitted with the conical surface of the bidirectional tapered hole as well as ensuring, efficiency required by the helical movement.

In the bolt and nut having bidirectional tapered thread, when the right-angled trapezoid union rotates a circle at a constant speed, an axial movement distance of the right-angled trapezoid union is equal to a length of the sum of the right-angled sides of, the two right-angled trapezoids, wherein the two right-angled trapezoids have same lower sides and upper sides, but different right-angled sides. This structure ensures that the first helical conical surface of the truncated cone body and the second helical conical surface of the truncated cone body as well as the first helical conical surface of the tapered hole and the second helical conical surface of the tapered hole have sufficient length, thus ensuring sufficient effective contact area and intensity when the conical surface of the bidirectional truncated cone body is fitted with the conical surface of the bidirectional tapered hole as well as ensuring efficiency required by the helical movement.

In the bolt and nut having bidirectional tapered thread, the first helical conical surface of the truncated cone body and the second helical conical surface of the truncated cone body are continuous helical surfaces or discontinuous helical surfaces. The first helical conical surface of the tapered hole and the second helical conical surface of the tapered hole are continuous helical surfaces or discontinuous helical surfaces.

In the bolt and nut having bidirectional tapered thread, when a connecting hole of the cylindrical body is screwed into a screw-in end of the columnar body, a screw-in direction is required, i.e., the connecting hole of the cylindrical body cannot be screwed in a reverse direction.

In the bolt and nut having bidirectional tapered thread, a head with a size greater than an outer diameter of the columnar body is arranged at one end of the columnar body, and/or a head with a size smaller than a minor diameter of the bidirectional tapered external thread of the screw body of the columnar body is arranged at one end and/or two ends of the columnar body, and the connecting hole is a threaded hole arranged on the nut. Namely, the columnar body connected with the head herein is a bolt; and the columnar body having no head and/or having heads at both ends smaller than the minor diameter of the bidirectional tapered external thread and/or having no thread at the middle and having the bidirectional tapered external threads at both ends is a stud, and the connecting hole is arranged in the nut.

Compared with the prior art, the connection structure of the bolt and the nut having bidirectional tapered thread has the advantages of reasonable design, simple structure, convenient operation, large locking force, high bearing capacity, excellent anti-loosening performance, high transmission efficiency and precision, good mechanical sealing effect and good stability, realizes the fastening and connecting functions through bidirectional bearing or sizing of cone pair formed by coaxial inner and outer diameter sizing of the internal cone and the external cone until interference fit, can prevent loosening phenomenon during connection, and has self-locking and self-positioning functions.

### BRIEF DESCRIPTION OF THE DRAWINGS

FIG. 1 is a schematic diagram of a connection structure of a bolt and double nuts of a dumbbell-like shaped (a left taper greater than a right taper) asymmetrical bidirectional tapered thread in Embodiment 1 provided by the disclosure.

FIG. 2 is a schematic diagram of a bolt of an external thread of the dumbbell-like shaped (the left taper greater than the right, taper) asymmetrical bidirectional tapered thread and a complete unit thread of the external thread in Embodiment 1 provided by the disclosure.

FIG. 3 is a schematic diagram of a bolt of an internal thread of the dumbbell-like shaped (the left taper greater than the right, taper) asymmetrical bidirectional tapered thread and a complete unit thread of the internal thread in Embodiment 1 provided by the disclosure.

FIG. 4 is a schematic diagram of a connection structure of a bolt and a single nut of a dumbbell-like shaped (a left taper greater than a right taper) asymmetrical bidirectional tapered thread in Embodiment 2 provided by the disclosure.

FIG. 5 is a schematic diagram of a connection structure of a bolt and double nuts of a dumbbell-like shaped (a left taper greater than a right taper) asymmetrical bidirectional tapered thread, in Embodiment 3 provided by the disclosure.

FIG. 6 is a schematic diagram of a connection structure of a bolt and double nuts (provided with a spacer like a gasket therebewteen) of the dumbbell-like shaped (the left taper greater than the right taper) asymmetrical bidirectional tapered thread in Embodiment 3 provided by the disclosure.

FIG. 7 is a schematic diagram of a connection structure of a bolt and double nuts of a dumbbell-like shaped (a left taper smaller than a right taper) asymmetrical bidirectional tapered thread in Embodiment 4 provided by the disclosure.

FIG. 8 is a schematic diagram of a bolt of an external thread of the dumbbell-like shaped (the left taper smaller than the right taper) asymmetrical bidirectional tapered thread and a complete unit thread of the external thread in Embodiment 4 provided by the disclosure.

FIG. 9 is a schematic diagram of a bolt of an internal thread of the dumbbell-like shaped (the left taper smaller than the right taper) asymmetrical bidirectional tapered thread and a complete unit thread of the internal thread in Embodiment 4 provided by the disclosure.

FIG. 10 is a schematic diagram of a connection structure of a bolt of two dumbbell-like shaped asymmetrical bidirectional tapered external threads comprising a dumbbell-like shaped (a left taper smaller than a right taper) asymmetrical bidirectional tapered thread and a dumbbell-like shaped (a left taper greater than a right taper) asymmetrical bidirectional tapered thread and double nuts of the dumbbell-like shaped asymmetrical bidirectional tapered thread provided in Embodiment 5 of the disclosure.

FIG. 11 is a schematic diagram of a connection structure of a bolt of an external thread of a dumbbell-like shaped asymmetrical bidirectional tapered external thread comprising taper structure forms of the dumbbell-like shape (the left taper smaller than the right taper) and the dumbbell-like shape (the left taper greater than the right taper) on a single screw body and double nuts of the dumbbell-like shaped asymmetrical bidirectional tapered thread and a complete unit thread of the external thread provided in Embodiment 5 of the disclosure.

FIG. 12 is a schematic diagram of a bolt of an internal thread of the dumbbell-like shaped (the left taper smaller than the right taper) asymmetrical bidirectional tapered thread and a complete unit thread of the internal thread in Embodiment 5 provided by the disclosure.

FIG. 13 is a schematic diagram of a bolt of an internal thread of the dumbbell-like shaped (the left taper greater than the right taper) asymmetrical bidirectional tapered thread and a complete unit thread of the internal thread in Embodiment 5 provided by the disclosure.

FIG. 14 is a graphic presentation of that “the thread of the existing thread technology is an inclined plane on a cylindrical or conical surface” involved in the background of the disclosure.

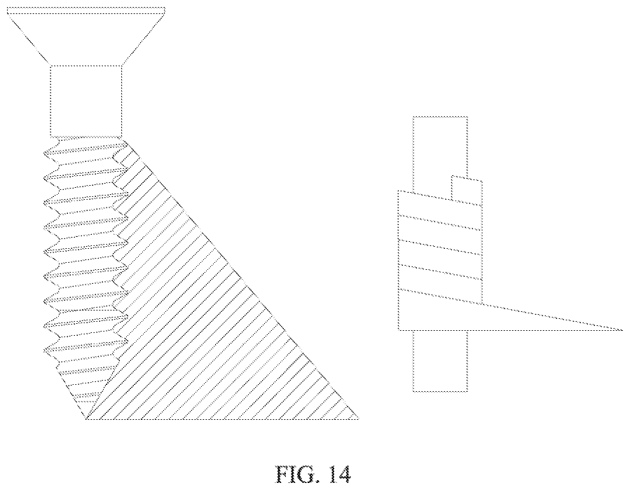

FIG. 15 is a graphic presentation of that “an inclined plane slider model of the principle of the existing thread technology—the principle of inclined plane” involved in the background of the disclosure.

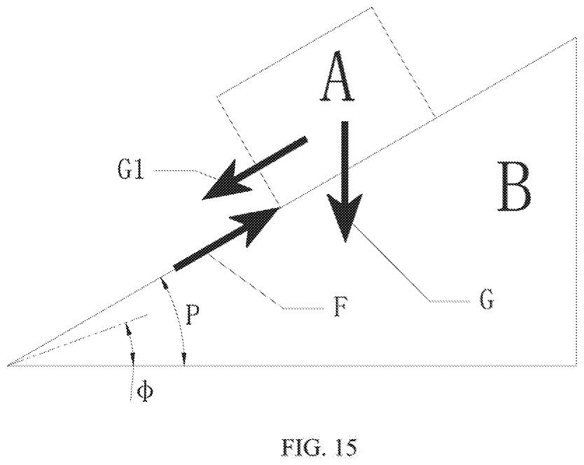

FIG. 16 is a graphic presentation of “a thread rise angle of the existing thread technology” involved in the background of the disclosure

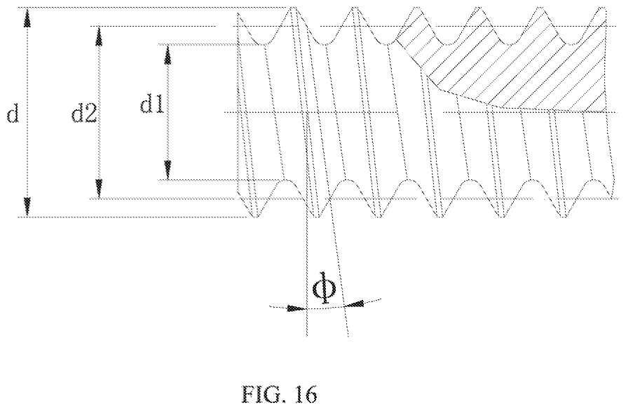

In the figures, tapered thread 1, cylindrical body 2, nut body 21, nut body 22, columnar body 3, screw body 31, slick rod 20, tapered hole 4, bidirectional tapered hole 41, conical surface 42 of the bidirectional tapered hole, first helical conical surface 421 of the tapered hole, first taper angle α1, second helical conical surface 422 of the tapered hole, second taper angle α2, internal helical line 5, internal thread 6, truncated cone body 7, bidirectional truncated cone body 71, conical surface 72 of the bidirectional truncated cone body, first helical conical surface 721 of the truncated cone body, first taper angle α1, second helical conical surface 722 of the truncated cone body, second taper angle α2, external helical line 8, external thread 9, dumbbell-like shape 94, left taper 95, right taper 96, left-direction distribution 97, right-direction distribution 98, thread connection pair and/or thread pair 10, clearance 101, locking bearing surface 111, locking bearing surface 112, tapered thread bearing surface 122, tapered thread bearing surface 121, workpiece 130, cone axis 01, thread axis 02, slider A on the inclined surface, inclined surface B, gravity (3, gravity component G1 along the inclined plane, friction force F, thread rise angle φ, equivalent friction angle P, major diameter d of the traditional external thread, minor diameter d1 of the traditional external thread and pitch diameter d2 of the traditional external thread.

### DETAILED DESCRIPTION

The disclosure will be further described in detail below with reference to the accompany drawings and specific embodiments.

### Embodiment 1

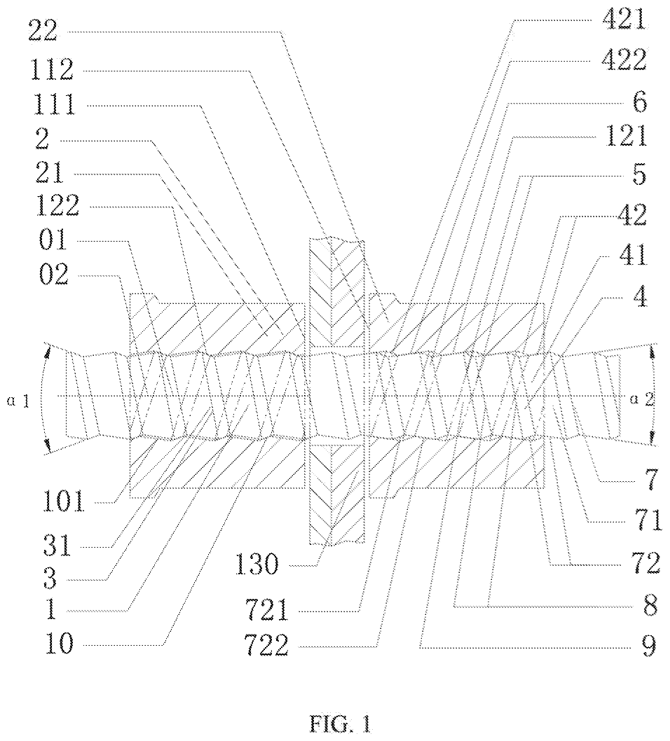

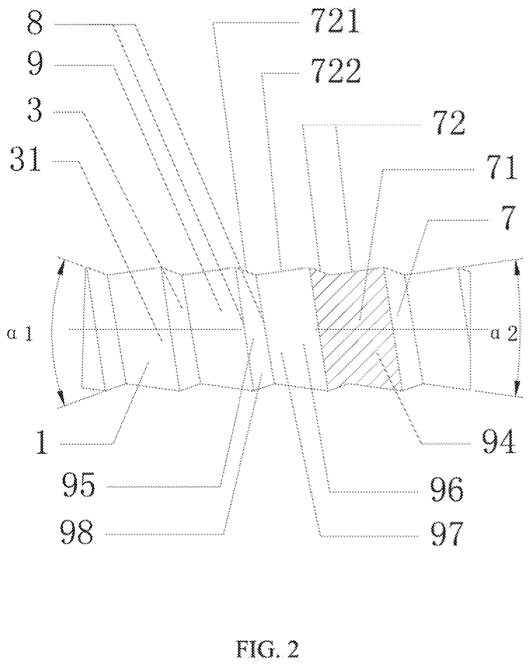

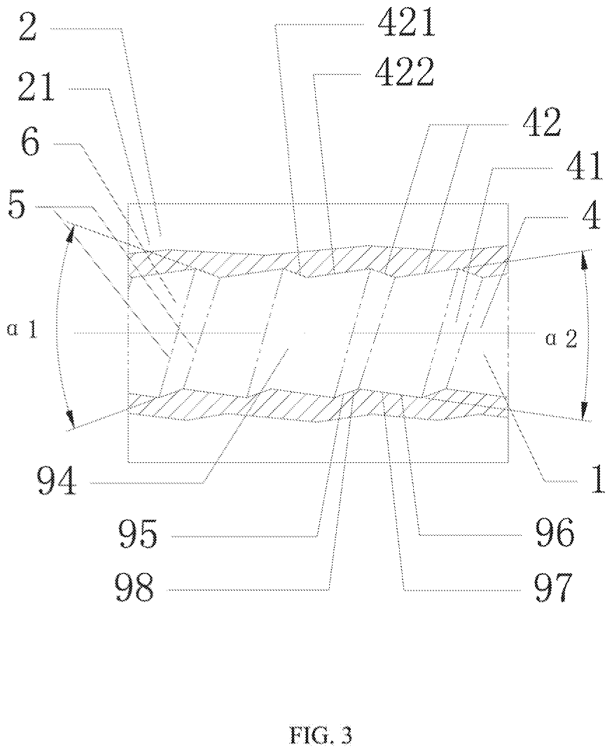

As shown in FIGS. 1 to 3, a connection structure of a bolt and double nuts is adopted in the embodiment, comprising a bidirectional truncated cone body 71 helically distributed on an outer surface of a columnar body 3, and a bidirectional tapered hole 41 helically distributed on an inner surface of a cylindrical body 2, i.e., comprises an external thread 9 and an internal thread 6 in mutual thread fit, wherein the internal thread 6 is presented by the helical bidirectional tapered hole 41 and exists in a form of a “non-entity space”, while the external thread 9 is presented by the helical bidirectional truncated cone body 71 and exists in a form of a “material entity”. The internal thread 6 and the external thread 9 are in a relationship of a containing part and a contained part: the internal thread 6 and the external thread 9 are sleeved together by screwing bidirectional tapered geometries in pitches and cohered till interference fit. The bidirectional tapered hole 41 contains the bidirectional truncated cone body 71 in pitches. The bidirectional containment limits a disordered degree of freedom between the tapered hole 4 and the truncated cone body 7; and the helical movement enables the tapered thread connection pair 10 of the bolt and nut having metrical, bidirectional tapered to obtain a necessary ordered degree of freedom, thus effectively combining technical characteristics of a cone pair and, a thread pair.

According to the bolt and nut having bidirectional tapered thread in the embodiment, the tapered thread connection pair 10 has the self-locking and self-positioning performances only if the truncated cone body 7 and/or the tapered hole, i.e., the cone body forming the cone pair reaches a certain taper angle. The taper comprises a left taper 95 and a right taper 96. The taper angle comprises a left taper angle and a right taper angle. In the asymmetrical bidirectional tapered thread 1 of the embodiment, the left taper 95 is greater than the right taper 96. The left taper 95 corresponds to the left taper angle, i.e., a first taper angle α1. It is preferable that the first taper angle α1 is greater than 0° and smaller than 53°; and preferably, the first taper angle α1 is 2°-40° In individual special fields transmission connection application fields without self-locking and/or with low requirements on self-positioning performances and/or with high requirements on axial bearing capacity, it is preferable that the first taper angle α1 is greater than or equal to 53′ and smaller than 180°; and preferably, the first taper angle α1 is 53°-90°. The right taper 96 corresponds to the right taper angle, i.e., a second taper angle α2. It is preferable that the second taper angle α2 is greater than 0° and smaller than 53°; and preferably, the second taper angle α2 is 2°-40°.

The external thread 9 is arranged on the outer surface of the columnar body 3, wherein the columnar body 3 is provided with a screw body 31. The truncated cone body 7 is helically distributed on an outer surface of the screw body 31, comprising an asymmetrical bidirectional truncated cone body 71. The asymmetrical bidirectional truncated cone body 71 is a dumbbell-like shaped 94 special bidirectional tapered geometry. The columnar body 3 may be solid or hollow, comprising a cylinder, a cone, body, a tubular body, and other workpieces and objects that need to be machined with external threads on outer surfaces thereof.

The dumbbell-like shaped 94 asymmetrical bidirectional truncated cone body 71 is formed by oppositely jointing two asymmetrical upper sides of two truncated cone bodies, wherein the two tapered holes have same lower sides and upper sides, but different cone heights, and the lower sides of the two truncated cone bodies are located at two ends of the bidirectional truncated cone body 71 and are mutually jointed with the lower sides of the adjacent bidirectional truncated cone body 71 and/or to be mutually jointed with the lower sides of the adjacent bidirectional truncated cone body 71. A conical surface 72 of the asymmetrical bidirectional truncated cone body is arranged on an outer surface of the truncated cone body 7. The external thread 9 comprises a first helical conical surface 721 of the truncated cone body, a second helical conical surface 722 of the truncated cone body and an external helical line 8. In a cross section through which the thread axis 02 passes, the complete single-pitch asymmetrical bidirectional tapered external thread 9 is a dumbbell-like shaped 94 special bidirectional tapered geometry small in the middle and large in both ends. Moreover, the taper of the truncated cone body in the left side is greater than the taper of the truncated cone body in the right side. The asymmetrical bidirectional truncated cone body 71 comprises a conical surface 72 of the bidirectional truncated cone body. An angle formed between two plain lines of a left conical surface of the bidirectional truncated cone body 71, i.e., the first helical conical surface 721 of the truncated cone body, is the first taper angle α1. The left taper 95 is formed on the first helical conical surface 721 of the truncated cone body, and is subjected to a right-direction distribution 98. An angle formed between two plain lines of a right conical surface of the asymmetrical bidirectional truncated cone body 71, i.e., the second helical conical surface 722 of the truncated cone body, is the second taper angle α2. The right taper 96 is formed on the second helical conical surface 722 of the truncated cone body, and is subjected to a left-direction distribution 97. The taper directions corresponding to the first taper angle α1 and the second taper angle α2 are opposite. The plain line is an intersection line of the conical surface and the plane through which the cone axis 01 passes. A shape formed by the first helical conical surface 721 of the truncated cone body and the second helical conical surface 722 of the truncated cone body of the bidirectional truncated cone body 71 is the same as a shape of a helical outer flank of a rotating body, wherein the rotating body is formed by two hypotenuses of a right-angled trapezoid union being rotated around a right-angled side of the right-angled trapezoid union, and, at the same time, the right-angled trapezoid union axially moves at a constant speed along a central axis of, the columnar body 3; wherein the right-angled trapezoid union refers to a special geometry formed by oppositely jointing two asymmetrical upper sides of two right-angled trapezoids, the two right-angled trapezoids have same lower sides and upper sides, but different right-angled sides and the lower sides of the two right-angled trapezoids are respectively located at two ends of the right-angled trapezoid union; and the two right-trapezoids are coincident with the central axis of the columnar body 3.

The internal thread 6 is arranged on the inner surface of the cylindrical body 2, wherein the cylindrical body 2 is provided with a nut body 21 and a nut body 22. A tapered hole 4 is helically distributed on an inner surface of the nut body 21 and an inner surface of the nut body 22 respectively. The tapered hole 4 comprises an asymmetrical bidirectional tapered hole 41. The symmetrical bidirectional tapered hole 41 is a dumbbell-like shaped 94 special bidirectional tapered geometry, and the cylindrical body 2 comprises cylindrical and/or non-cylindrical workpieces and objects that need to be machined with internal threads on inner surfaces thereof.

The dumbbell-like shaped 94 asymmetrical bidirectional tapered hole 41 is formed by oppositely jointing two asymmetrical upper sides of two tapered holes, wherein the two tapered holes have same lower sides and upper sides but different cone heights, and the lower sides of the two tapered holes are located at two ends of the bidirectional tapered hole 41 and are mutually jointed with the lower sides of the adjacent asymmetrical bidirectional tapered hole 41 and/or to mutually jointed with the lower sides of the adjacent asymmetrical bidirectional tapered hole 41. The tapered hole 4 comprises a conical surface 42 of the asymmetrical bidirectional tapered hole. The internal thread 6 comprises a first helical conical surface 421 of the tapered hole, a second helical conical surface 422 of the tapered hole and an internal helical line 5. In a cross section through which the thread axis 02 passes, the complete single-pitch asymmetrical bidirectional tapered internal thread 6 is a dumbbell-like shaped 94 special bidirectional tapered geometry small in the middle and large in both ends, and the taper of the tapered hole in the left side is greater than the taper of the tapered hole in the right side. The bidirectional tapered hole 41 comprises a conical surface 42 of the bidirectional tapered hole. An, angle formed between two plain lines of a left conical surface of the bidirectional tapered hole 41, i.e., the first helical conical surface 421 of the tapered hole, is the first taper angle α1. The left taper 95 is formed on the first helical conical surface 421 of the tapered hole, and is subjected to a right-direction distribution 98. An angle formed between two plain lines of a right conical surface of the bidirectional tapered hole 41, i.e., the second helical conical surface 422 of the tapered hole, is the second taper angle α2. The right taper 96 is formed on the second helical conical surface 422 of the tapered hole, and is subjected to a left-direction distribution 97. The taper directions corresponding to the first taper angle α1 and the second taper angle α2 are opposite. The plain line is an intersection line of the conical surface and the plane through which the cone axis 01 passes. A shape formed by the first helical conical surface 421 of the tapered hole and the second helical conical surface 422 of the tapered hole of the bidirectional tapered hole 41 is the same as a shape of a helical outer flank of a rotating body, wherein the rotating body is formed by two hypotenuses of a right-angled trapezoid union being rotated around a right-angled side of the right-angled trapezoid union, and, at the same time, the right-angled trapezoid union axially moves at a constant speed along a central axis of the cylindrical body 2; wherein the right-angled trapezoid union refers to a special geometry formed by oppositely jointing two asymmetrical upper sides of two right-angled trapezoids, the two right-angled trapezoids have same lower sides and upper sides, but different right-angled sides and the lower sides of the two right-angled trapezoids are respectively located at two ends of the right-angled trapezoid union; and the two right-trapezoids are coincident with the central axis of the cylindrical body 2.

A connection structure of a bolt and double nuts is adopted in the embodiment. The double nuts comprise a nut body 21 and a nut body 22. The nut body 21 is located at a left side of the fastened workpiece 130, while the nut body 22 is located at a right side of the fastened workpiece 130. When the bolt and the double nuts are working, a relationship with the fastened workpiece 130 is rigid connection. The rigid connection means that an end surface bearing surface of the nut and a bearing surface of the workpiece 130 are mutually bearing surfaces, comprising a bearing surface 111 and a locking bearing surface 112. The workpiece 130 refers to a connected object comprising the workpiece 130.

Working bearing surfaces of the thread in the embodiment are different, comprising a tapered thread bearing surface 121 and a tapered thread bearing surface 122. When the cylindrical body 2 is located at a left side of the fastened workpiece 130, i.e., a left end surface of the fastened workpiece 130, and a right end surface of the cylindrical body 2 (i.e., the left nut body 21) is the locking bearing surface 111 between the left nut body 21 and the fastened workpiece 130, the left helical conical surfaces of the bidirectional tapered threads 1 of the left nut body 21 and the columnar body 3 (i.e., the screw body 31), i.e., the bolt, are the tapered thread bearing surfaces. Namely, the first helical conical surface 421 of the tapered hole and the first helical conical surface 721 of the truncated cone body are the tapered thread bearing surface 122; and the first helical conical surface 421 of the tapered hole and the first helical conical surface 721 of the truncated cone body are mutually bearing surfaces. When the cylindrical body 2 is located at a right side of the fastened workpiece 130, i.e., a right end surface of the fastened workpiece 130, and a left end surface of the cylindrical body 2 (i.e., the right nut body 22) is the locking bearing surface 112 between the right nut body 22 and the fastened workpiece 130, the right helical conical surfaces of the bidirectional tapered threads 1 of the right nut body 22 and the columnar body 3 (i.e., the screw body 31), i.e., the bolt, are the tapered thread bearing surfaces. Namely, the second helical conical surface 422 of the tapered hole and the second helical conical surface 722 of the truncated cone body are the tapered thread bearing surfaces 121; and the second helical conical surface 422 of the tapered hole and the second helical conical surface 722 of the truncated cone body are mutually bearing surfaces.

During transmission connection of the bolt and nut having bidirectional tapered thread, bidirectional bearing is implemented through screwing connection of the bidirectional tapered hole 41 and the bidirectional truncated cone body 71. A clearance 101 between the bidirectional truncated cone body 71 and the bidirectional tapered hole 41 is required. The clearance 101 is beneficial to the formation of the bearing oil film. The tapered thread connection pair 10 is equivalent to a pair of sliding bearings consisting of one pair and/or several pairs of sliding bearings; namely, each pitch of the traditional internal thread 6 bidirectionally contains a corresponding pitch of traditional external thread 9 to form a pair of sliding bearings, A number of the formed sliding bearings is adjusted according to the application conditions, namely, a pitch number of containing and contained threads cohered by the effectively bidirectional jointing, i.e., effectively bidirectional contact of the bidirectional tapered internal thread 6 and the bidirectional tapered external thread 9 is designed according to application conditions. Through the bidirectional containment of the truncated cone body 71 by the tapered hole 4, by virtue of positioning in multiple directions such as radial, axial, angular and circumferential, the precision, efficiency and reliability of the transmission connection of the bidirectional tapered thread are ensured.

When the bolt and nut having bidirectional tapered thread is tightly connected and hermetically connected, technical performances thereof are realized through the screwing connection of the bidirectional tapered hole 41 and the bidirectional truncated cone body 71, namely, the technical performances are realized through sizing of the first helical conical surface 721 of the truncated cone body and the first helical conical surface 421 of the tapered hole till interference and/or sizing of the second helical conical surface 722 of the truncated cone body and the second helical conical surface 422 of the tapered hole till interference. According to application conditions, one direction bears the load and/or two directions simultaneously respectively bear the load. Namely, under the guidance of the helical line, an outer diameter of an internal cone of the bidirectional truncated cone body 71 and an inner diameter of an external cone of the bidirectional tapered hole 41 are centered till the first helical conical surface 421 of the tapered hole is cohered with the first helical conical surface 721 of the truncated cone body till interference contact and/or the second helical conical surface 422 of the tapered hole is connected with the second helical conical surface 722 of the truncated cone body till interference contact, thus realizing technical performances such as connection, locking, anti-loosening, bearing, fatigue and sealing of mechanical fastening structures.

Therefore, the technical performances such as the transmission precision and efficiency, the load bearing capacity, the locking force of self-locking, the anti-loosening ability, the sealing performance and the reusability of the bolt and nut having bidirectional tapered thread in the embodiment are related to the sizes of the first helical conical surface 721 of the truncated cone body and the formed left taper 95, i.e., the first taper angle α1, and the second helical conical surface 722 of the truncated cone body and the formed right taper 96, i.e., the second taper angle α2, as well as the sizes of the first helical conical surface 421 of the tapered hole and the formed left taper 95, i.e., the first taper angle α1, and the second helical conical surface 422 of the tapered hole and the formed right taper 96, i.e., the second taper angle α2. Material friction coefficient, processing quality and application conditions of the columnar body 3 and the cylindrical body 2 also have a certain impact on the cone fit.

In the bolt and nut having bidirectional tapered thread, when the right-angled trapezoid union rotates a circle at a constant speed, an axial movement distance of the right-angled trapezoid union is at least double a length of the sum of the right-angled sides of the two right-angled trapezoids, wherein the two right-angled trapezoids have same lower sides and upper sides, but different right-angled sides. The structure ensures that the first helical conical surface 721 of the truncated cone body and the second helical conical surface 722 of the truncated cone body as well as the first helical conical surface 421 of the tapered hole and the second helical conical surface 422 of the tapered hole, have sufficient length, thereby ensuring that the conical surface 72 of the bidirectional truncated cone body and the conical surface 42 of the bidirectional tapered hole have sufficient effective contact area and strength and the efficiency required by helical movement during fitting.

In the bolt and nut having bidirectional tapered thread, when the right-angled trapezoid union rotates a circle at a constant speed, an axial movement distance of the right-angled trapezoid union is equal to a length of the sum of the right-angled sides of the two right-angled trapezoids, wherein the two right-angled trapezoids have same lower sides and upper sides, but different right-angled sides. The structure ensures that the first helical conical surface 721 of the truncated cone body and the second helical conical surface 722 of the truncated cone body as well as the first helical conical surface 421 of the tapered hole and the second helical conical surface 422 of the tapered hole have sufficient length, thereby ensuring that the conical surface 72 of the bidirectional truncated cone body and the conical surface 42 of the bidirectional tapered hole have sufficient effective contact area and strength and the efficiency required by helical movement during fitting.

In the bolt and nut having bidirectional tapered thread, the first helical conical surface 721 of the truncated cone body and the second helical conical surface 722 of the truncated cone body are continuous helical surfaces or discontinuous helical surfaces. The first helical conical surface 421 of the tapered hole and the second helical conical surface 422 of the tapered hole are continuous helical surfaces or discontinuous helical surfaces.

In the bolt and nut having bidirectional tapered thread, when a connecting hole of the cylindrical body 2 is screwed into a screw-in end of the columnar body 3, a screw-in direction is required, and the connecting hole cannot be screwed in a reverse direction.

In the bolt and nut having bidirectional tapered thread, a head with a size greater than an outer diameter of the columnar body 3 is arranged at one end of the columnar body 3, and/or a head with a size smaller than a minor diameter of the external thread 9 of the tapered thread of the screw body 31 of the columnar body 3 is arranged at one end and/or two ends of the columnar body 3, and the connecting hole is a threaded hole arranged on the nut body 21. Namely, the columnar body 3 connected with the head herein is a bolt; and the columnar body having no head and/or having heads at both ends smaller than the minor diameter of the bidirectional tapered external thread 9 and/or having no thread at the middle and having the bidirectional tapered external threads 9 at both ends is a stud, and the connecting hole is arranged in the nut body 21.

Compared with the prior art, in the tapered thread connection pair 10 of the connection structure of the bolt and the nut having bidirectional tapered thread has the advantages of reasonable design, simple structure, convenient operation, large locking force, high bearing capacity, excellent anti-loosening performance, high transmission efficiency and precision, good mechanical sealing effect and good stability, realizes the fastening and connecting functions through sizing of the cone pair formed by the internal cone and the external cone until interference fit, can prevent loosening phenomenon during connection, and has self-lockin and self-positioning functions.

### Embodiment 2

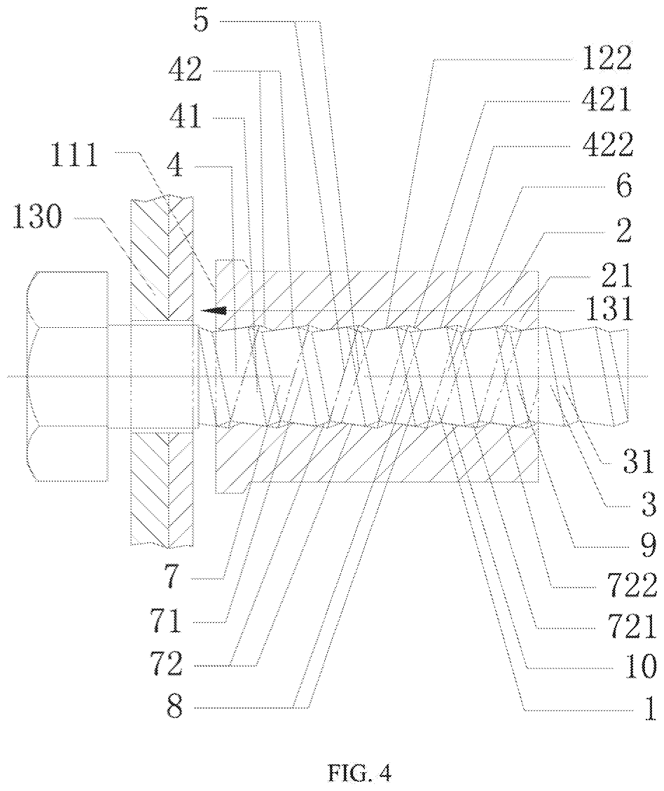

As shown in FIG. 4, the structure, principle and implementation steps of the embodiment are similar to that in Embodiment 1, and the differences are that the connection structure of the bolt and the single nut is adopted in the embodiment, and a bolt body is provided with a hexagon head greater than the screw body 31. When the hexagon head of the bolt is located at a left side, the cylindrical body 2 (i.e., the nut body 21), i.e., the single nut is located at a right side of the fastened workpiece 130. When the connection structure of the bolt and the single nut in the embodiment is working, a relationship with the fastened workpiece 130 is rigid connection. The rigid connection means that the end surface of the nut body 21 and the opposite end surface of the workpiece 130 are mutually bearing surfaces. The bearing surface is the locking bearing surface 111, and the workpiece 130 refers to a connected object comprising the workpiece 130.

The working bearing surface of the thread of the embodiment is the tapered thread bearing surface 122, i.e., the cylindrical body 2, i.e., the nut body 21, i.e., the single nut is located at the right side of the fastened workpiece 130. When the connection structure of the bolt and the single nut is working, a right end surface of the workpiece 130 and a left end surface of the nut body 21 are the locking bearing surface 111 between the nut body 21 and the fastened workpiece 130. Right helical conical surfaces of the bidirectional tapered threads 1 of the nut body 21 and the columnar body 3 (i.e., the screw body 31), i.e., the bolt, are the working bearing surfaces of the thread. Namely, the second helical conical surface 422 of the tapered hole and the second helical conical surface 722 of the truncated cone body are the tapered thread bearing surface 122, and the second helical conical surface 422 of the tapered hole and the second helical conical surface 722 of the truncated cone body are mutually bearing surfaces.

In the embodiment, when the hexagon head of the bolt is located in the right side, the structure, principle and implementation steps thereof are similar to that in Embodiment 1.

### Embodiment 3

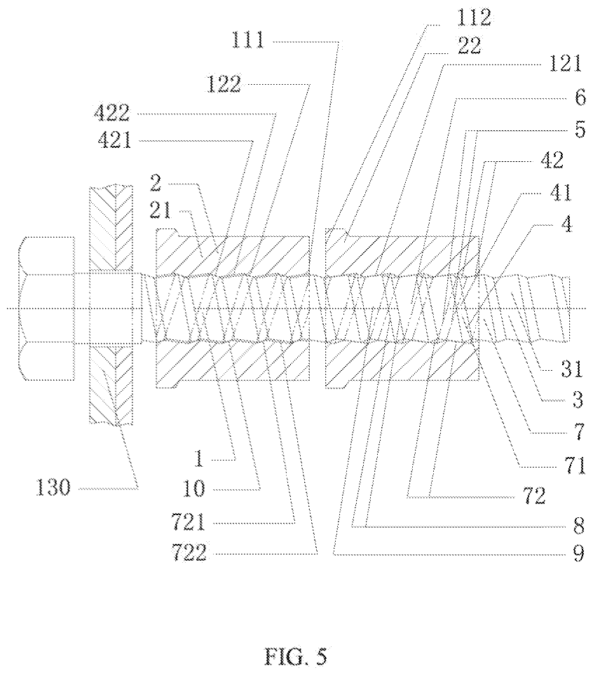

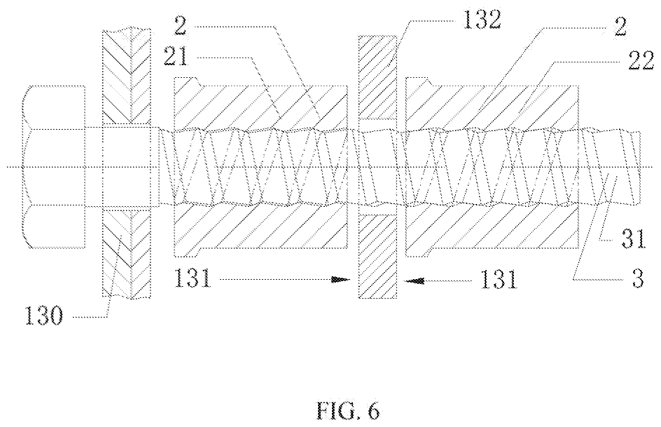

As shown in FIG. 5 and FIG. 6, the structure, principle and implementation steps of the embodiment are similar to that in Embodiment 1, and the differences are that a positional relationship between the double nuts and the fastened workpiece 130 is different. The double nuts comprise the nut body 21 and the nut body 22, and the bolt body has a hexagon head greater than the screw body 31. When the hexagon head of the bolt is located at a left side, both the nut body 21 and the nut body 22 are located at the right side of the fastened workpiece 130. When the connection structure of the bolt and the double nuts is working, a relationship between the nut body 21 and the nut body 22 with the fastened workpiece 130 is non-rigid connection. The non-rigid-connection means that opposite side end surfaces of the nut body 21 and the nut body 22 are mutually bearing surfaces. The bearing surfaces comprise the locking bearing surface 111 and the locking bearing surface 112. The non-rigid connection is mainly applied to non-rigid materials or non-rigid connection workpieces 130 such as transmission pieces and other application fields that need to be installed through double nuts to satisfy requirements, etc. The workpiece 130 refers to a connected object comprising the workpiece 130.

Working bearing surfaces of the thread of the embodiment are different, comprising the tapered thread bearing surface 121 and the tapered thread bearing surface 122. When the cylindrical body 2 comprises the left nut body 21 and the right nut body 22, a right end surface of the left nut body 21, i.e., the locking bearing surface 111 and a left end surface of the right nut body 22 i.e., the locking bearing surface 112 are oppositely and directly connected and are mutually locking bearing surfaces. When the right end surface of the left nut body 21 is the locking bearing surface 111, the left helical conical surfaces of the bidirectional tapered threads 1 of the left nut body 21 and the columnar body 3 (i.e., the screw body 31), i.e., the bolt, are the working bearing surfaces of the thread. Namely, the first helical conical surface 421 of the tapered hole and the first helical conical surface 721 of the truncated cone body are the tapered thread bearing surface 122, and the first helical conical surface 421 of the tapered hole and the first helical conical surface 721 of the truncated cone body are mutually bearing surfaces. When the left end surface of the right nut body 22 is the locking bearing surface 112, the right helical conical surfaces of the bidirectional tapered threads 1 of the right nut body 22 and the columnar body 3 (i.e., the screw body 31), i.e., the bolt, are the working bearing surfaces of the thread. Namely, the second helical conical surface 422 of the tapered hole and the second helical conical surface 722 of the truncated cone body are the tapered thread bearing surface 121 and the second helical conical surface 422 of the tapered hole and the second helical conical surface 722 of the truncated cone body are mutually bearing surfaces.

In the embodiment, when the cylindrical body 2 located inside, i.e., the nut body 21 adjacent with the fastened workpiece 130 is already effectively combined together with the columnar body 3 (i.e., screw body 31), i.e., the bolt, namely, the internal thread 6 and the external thread 9 forming the tapered thread connection pair 10 are effectively cohered together, the cylindrical body 2 located outside, i.e., the nut body 22 not adjacent with the fastened workpiece 130 may keep an original situation and/or be dismounted with one nut (for example, such application fields having lightweight requirements on equipment or not needing double nuts to ensure the reliability of the connection technology) according to application conditions. The dismounted nut body 22 is not used as a connection nut, but only used as an installation process nut. An internal thread of the installation process nut is not only manufactured by adopting bidirectional tapered threads, and may also be a nut body 22 made of unidirectional tapered threads and other threads that can be screwed with the tapered threads 1, i.e., threads comprising triangular threads, trapezoidal threads, sawtooth threads and other non-tapered threads, but are not limited to the above threads. On the premise of ensuring the reliability of the connection technology, the tapered thread connection pair 10 is a closed-loop fastening technical system, namely, after the internal thread 6 and the external thread 9 of the tapered thread connection pair 10 are effectively cohered together, the tapered thread connection pair 10 will become an independent technical system without relying on technical compensations from a third party to ensure the technical effectiveness of the connection technical system. The effectiveness of the tapered thread connection pair 10 will not be affected even without the support of other objects and even if there is a gap between the tapered thread connection pair 10 and the fastened workpiece 130. This will greatly reduce the weight of the equipment, remove invalid loads, and improve the technical requirements on an effective loading capability, braking performance, and energy conservation and emission reduction of the equipment, which is a unique thread technical advantage no matter the relationship between the tapered thread connection pair 10 of the connection structure of the bolt and the nut having bidirectional tapered thread and the fastened workpiece 130 is non-rigid connection or rigid connection, and is not possessed by other thread technologies.

In the embodiments, when a gasket is provided between the nut body 21 and the nut body 22, the structure, principle and implementation steps thereof are similar to that in Embodiment 1.

In the embodiment, when the hexagon head of the bolt is located at the right side, then both the nut body 21 and the nut body 22 are located at the left side of the fastened workpiece 130, and the structure, principle and implementation steps thereof are similar to that in Embodiment 1.

### Embodiment 4

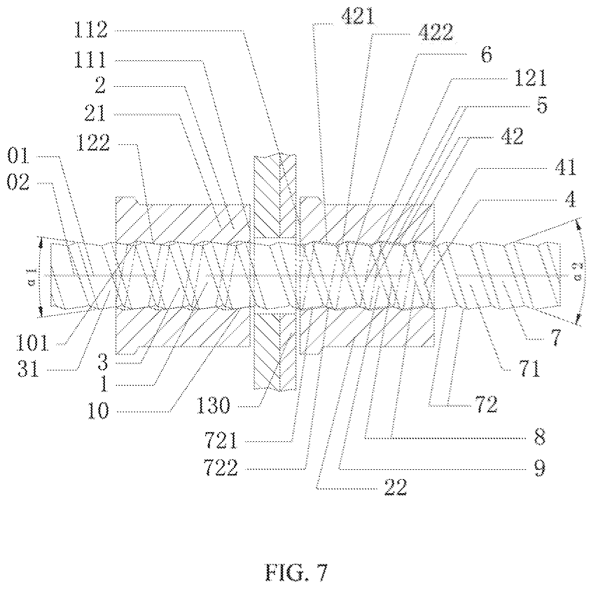

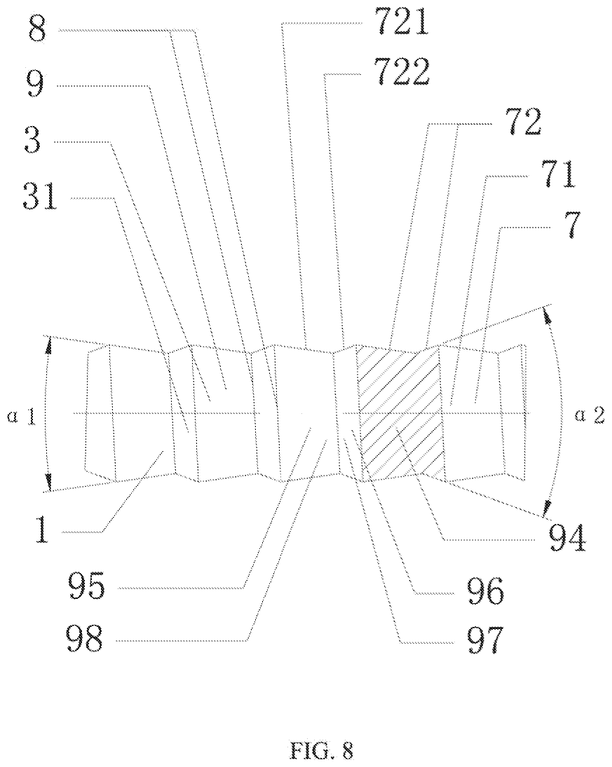

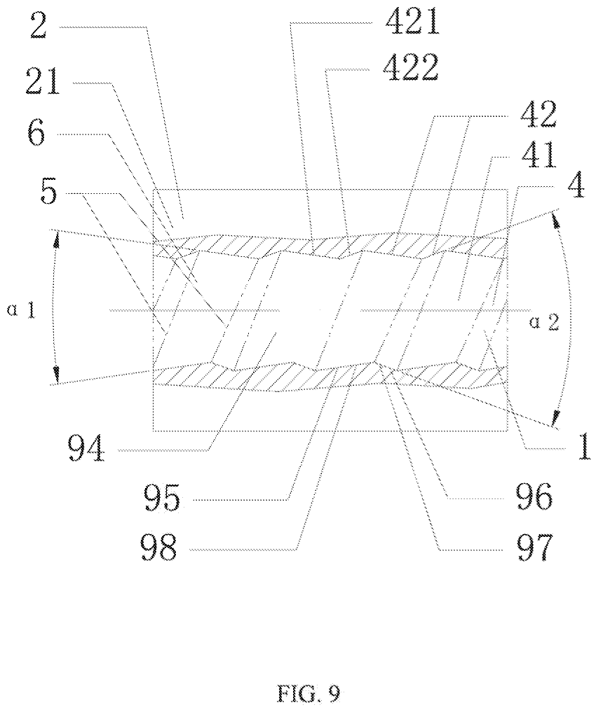

As shown in FIG. 7, FIG. 8 and FIG. 9, the structure, principle and implementation steps of the embodiment are similar to that in Embodiment 1, Embodiment 2 and Embodiment 3, and the differences are that the left taper 95 of the asymmetrical bidirectional tapered thread 1 in the embodiment is smaller than the right taper 96. It is preferable that, the first taper angle α1 is greater than 0° and smaller than 53°; and preferably, the first taper angle α1 is 2°-40°. It is preferable that the second taper angle α2 is greater than 0° and smaller than 53°; and preferably, the second taper angle α2 is 2°-40°. In individual special fields, it is preferable that the second taper angle α2 is greater than or equal to 53° and smaller than 180°; and preferably, the second taper angle α2 is 53°-90°.

### Embodiment 5

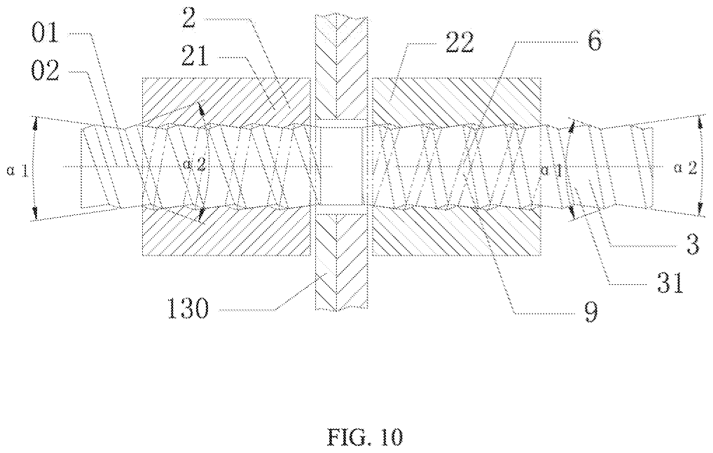

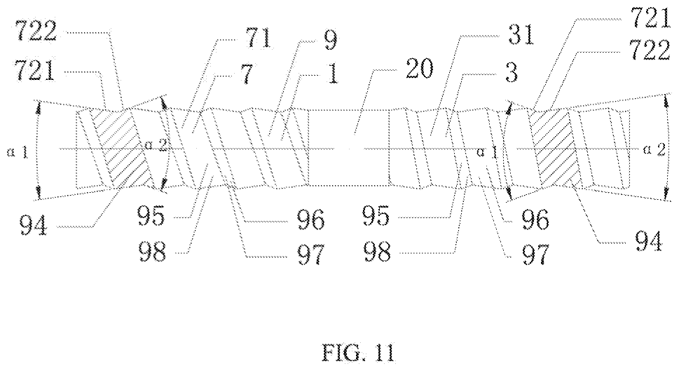

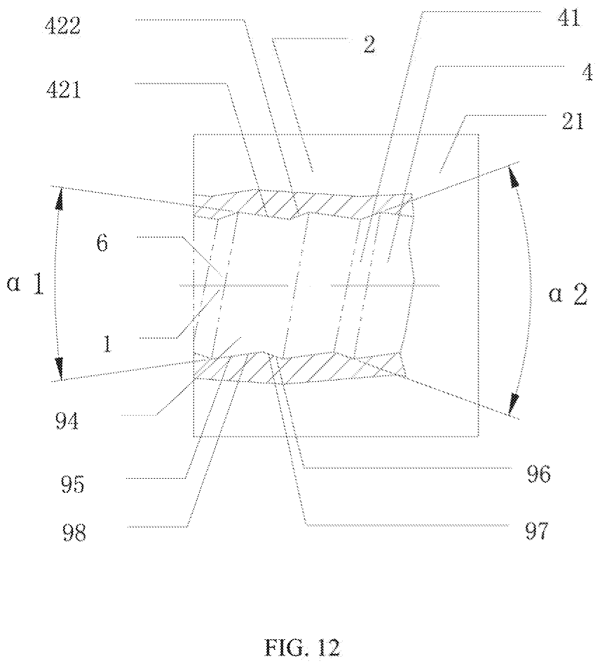

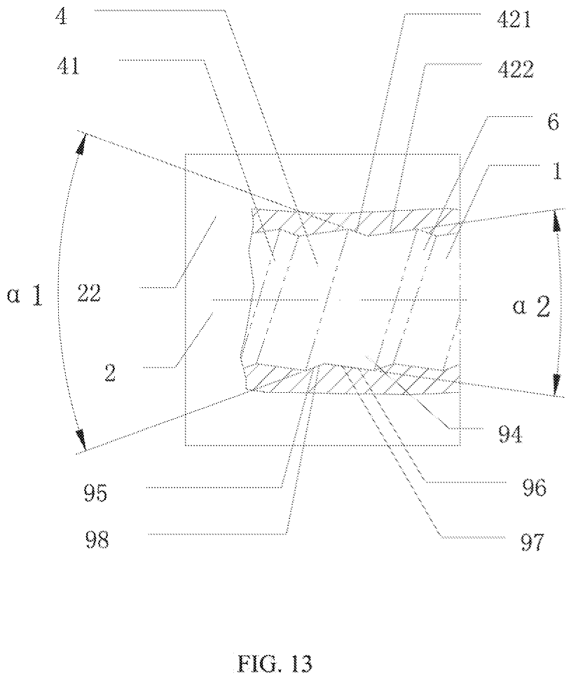

As shown in FIG. 10, FIG. 11, FIG. 12 and FIG. 13, the structure, principle and implementation steps of the embodiment are similar to that in Embodiment 1 and Embodiment 4, and the differences are, that the screw body 31 on the columnar body 3 comprises two thread structures of the dumbbell-like shaped 94 asymmetrical bidirectional tapered thread 1, namely, the asymmetrical bidirectional tapered thread 1 of the screw body 31 refers to the external threads 9 of the dumbbell-like shaped 94 asymmetrical bidirectional tapered threads in two structural forms comprising that the left taper 95 is smaller than the right taper 96 and the left taper 95 is greater than the a right taper 96. A thread section of the screw body 31 located at a left side of a slick rod 20, i.e., a non-thread section, is the dumbbell-like shaped 94 asymmetrical bidirectional tapered external thread 9 having the left taper 95 smaller than the right taper 96. Namely, the thread section of the external thread 9 in mutual thread fit with the cylindrical body 2 located at the left side of the workpiece 130, i.e., the nut body 21 is the dumbbell-like shaped 94 asymmetrical bidirectional tapered external thread 9 having the left taper 95 smaller than the right taper 96. A thread section of the screw body 31 located at a right side of the slick rod 20, i.e., a non-thread section, is the dumbbell-like shaped 94 asymmetrical bidirectional tapered external thread 9 having the left taper 95 greater than the right taper 96. Namely, the thread section of the external thread 9 in mutual thread fit with the cylindrical body 2 located at the right side of the workpiece 130, i.e., the nut body 22 is the dumbbell-like shaped 94 asymmetrical bidirectional tapered external thread 9 having the left taper 95 greater than the right taper 96.

In the embodiment, the following structure may also be adopted, comprising that the cylindrical body 2 located at the left side of the workpiece 130 i.e., the internal thread 6 of the nut body 21 is the dumbbell-like shaped 94 asymmetrical bidirectional tapered internal thread 6 having the left taper 95 greater than the right taper 96, and the cylindrical body 2 located at the right side of the workpiece 130, i.e., the internal thread 6 of the nut body 22 is the dumbbell-like shaped 94 asymmetrical bidirectional tapered internal thread 6 having the left taper 95 smaller than the right taper 96. Accordingly, the dumbbell-like shaped 94 asymmetrical bidirectional tapered thread 1 of the screw body 31 of the columnar body 3 will also comprise the dumbbell-like shaped 94 asymmetrical bidirectional tapered external threads 9 in two types of taper structure forms, i.e., the thread section of the screw body 31 located at the left side of the slick rod 20, i.e., the non-thread section, is the dumbbell-like shaped 94 asymmetrical bidirectional tapered external thread 9 having the left taper 95 greater than the right taper 96, and the thread section of the screw body 31 located at the right side of the slick rod 20, i.e., the non-thread section, is the dumbbell-like shaped 94 asymmetrical bidirectional tapered external thread 9 having the left taper 95 smaller than the right taper 96. Namely, the thread section of the external thread 9 at the left side of the screw body 31 in mutual thread fit with the nut body 21 is the dumbbell-like shaped 94 asymmetrical bidirectional tapered external thread 9 having the left taper 95 greater than the right taper 96, and the thread section of the external thread 9 at the right side of the screw body 31 in mutual thread fit with the nut body 22 is the dumbbell-like shaped 94 asymmetrical bidirectional tapered external thread having the left taper 95 smaller than the right taper 96. The structure, principle and implementation steps of the embodiment are similar to that of Embodiment 1 and Embodiment 4.

The combination of the bolt and the double nuts above adopts any combination form which shall be determined on the application requirements.

The specific embodiments described herein are merely examples to illustrate the spirit of the disclosure. Those skilled in the art of the disclosure can make various modifications or supplements to the specific embodiments described or substitute with similar modes without deviating from the spirit of the disclosure or going beyond the scope defined by the appended claims.

The terms such as tapered thread 1, cylindrical body 2, nut body 21, nut body 22, columnar body 3, screw body 31, slick rod 20, tapered hole 4, bidirectional tapered hole 41, conical surface 42 of the bidirectional tapered hole, first helical conical surface 421 of the tapered hole, first taper angle α1, second helical conical surface 422 of the tapered hole, second taper angle α1, internal helical line 5, internal thread 6, truncated cone body 7, bidirectional truncated cone body 71, conical surface 72 of the bidirectional truncated cone body, first helical conical surface 721 of the truncated cone body, first taper angle α1, second helical conical surface 722 of the truncated cone body, second taper angle α2, external helical line 8, external thread 9, dumbbell-like shape 94, left taper 95, right taper 96, left-direction distribution 97, right-direction distribution 98, thread connection pair and/or thread pair 10, clearance 101, self-locking force, self-locking, self-positioning, pressure, cone axis 01, thread axis 02, mirror image, shaft sleeve, shaft, non-entity space, material entity, single tapered body, double tapered body, cone body, internal cone body, tapered hole, external cone body, tapered body, cone pair, helical structure, helical movement, thread body, complete unit thread, axial force, axial force angle, counter-axial force, counter-axial force angle, centripetal force, counter-centripetal force, inversely collinear, internal stress, bidirectional force, unidirectional force, sliding bearing, sliding bearing pair are widely used, but the possibility of using other terms is not excluded. These terms are merely used to describe and explain the essence of the disclosure more conveniently; and it is contrary to the spirit of the disclosure to interpret the terms as any additional limitation.

What is claimed is:

1. A connection structure of a bolt and a nut having dumbbell-like shaped asymmetrical bidirectional tapered thread, comprising an external thread (9) and an internal thread (6) in mutual thread fit, wherein:
a complete unit thread of the dumbbell-like shaped asymmetrical bidirectional tapered thread (1) is a helical dumbbell-like shaped asymmetrical bidirectional tapered body small in the middle and large in both ends and comprising a bidirectional tapered hole (41) and/or a bidirectional truncated cone body (71);
the bidirectional tapered hole (41) and/or the bidirectional truncated cone body (71) have/has a left taper (95) and a right taper (96), wherein the left taper (95) is greater than the right taper (96) and/or the left taper (95) is smaller than the right taper (96):
a thread body of the internal thread (6) is the helical bidirectional tapered hole (41) on an inner surface of a cylindrical body (2), and exists in a form of a “non-entity space”;
a thread body of the external thread (9) is the helical bidirectional truncated cone body (71) on an outer surface of a columnar body (3), and exists in a form of a “material entity”;
the left taper (95) is formed on a left conical surface of the asymmetrical bidirectional tapered body and corresponds to a first taper angle (α1), and the right taper (96) is formed on a right conical surface of the asymmetrical bidirectional tapered body and corresponds to a second taper angle (α2);
the left taper (95) and the right taper (96) have opposite directions, and different tapers; and
the internal thread (6) and the external thread (9) contain the bidirectional truncated cone body by the bidirectional tapered hole till an inner conical surface of the bidirectional tapered hole and an outer conical surface of the bidirectional truncated cone body bear each other.

2. The connection structure according to claim 1, wherein the dumbbell-like shaped bidirectional tapered internal thread (6) comprises a left conical surface of a conical surface (42) of the bidirectional tapered hole, i.e., a first helical conical surface (421) of the tapered hole, a right conical surface of the conical surface (42) of the bidirectional tapered hole, i.e., a second helical conical surface (422) of the tapered hole, and an internal helical line (5);
a first shape formed by the first helical conical surface (421) of the tapered hole and the second helical conical surface (422) of the tapered hole, i.e., a bidirectional helical conical surface, is the same as, a shape of a helical outer flank of a first rotating body, wherein the first rotating body is formed by two hypotenuses of a right-angled trapezoid union being rotated around a right-angled side of the right-angled trapezoid union, and, at the same time, the right-angled trapezoid union axially moves at a constant speed along a central axis of the cylindrical body (2); wherein the right-angled trapezoid union is formed by oppositely jointing two asymmetrical upper sides of two right-angled trapezoids; the two right-angled trapezoids have same lower sides and upper sides, but different right-angled sides; and the two right-trapezoids are coincident with the central axis of the cylindrical body (2);
the dumbbell-like shaped bidirectional tapered external thread (9) comprises a left conical surface of a conical surface (72) of the bidirectional truncated cone body, i.e., a first helical conical surface (721) of the truncated cone body, a right conical surface of the conical surface (72) of the bidirectional truncated cone body, i.e., a second helical conical surface (722) of the truncated cone body, and an external helical line (8); and
a second shape formed by the first helical conical surface (721) of the truncated cone body and the second helical conical surface (722) of the truncated cone body, i.e., a bidirectional helical conical surface, is the same as a shape of a helical outer flank of a second rotating body, wherein the second rotating body is formed by two hypotenuses of a right-angled trapezoid union being rotated around a right-angled side of the right-angled trapezoid union, and, at the same time, the right-angled trapezoid union axially moves at a constant speed along a central axis of the columnar body (3); wherein the right-angled trapezoid union is formed by oppositely jointing two asymmetrical upper sides of two right-angled trapezoids; the two right-angled trapezoids have same lower sides and upper sides, but different right-angled sides; and the two right-trapezoids are coincident with the central axis of the columnar body (3).

3. The connection structure according to claim 2, when the right-angled trapezoid union rotates a circle at a constant speed, an axial movement distance of the right-angled trapezoid union is at least double a length of the sum of the right-angled sides of the two right-angled trapezoids of the right-angled trapezoid union.

4. The connection structure according to claim 2, when the right-angled trapezoid union rotates a circle at a constant speed, an axial movement distance of the right-angled trapezoid union is equal to a length of the sum of the right-angled sides of the two right-angled trapezoids of the right-angled trapezoid union.

5. The connection structure according to claim 2, wherein the left conical surface and the right conical surface of the bidirectional tapered body, i.e., the first helical conical surface (421) of the tapered hole and the second helical conical surface (422) of the tapered hole, and the internal helical line (5) are continuous helical surfaces or discontinuous helical surfaces; and
the first helical conical surface (721) of the truncated cone body, the second helical conical surface (722) of the truncated cone body, and the external helical line (8) are continuous helical surfaces or discontinuous helical surfaces.

6. The connection structure according to claim 1, wherein the internal thread (6) is formed by oppositely jointing two asymmetrical upper sides of two tapered holes (4), wherein the two tapered holes (4) have same, lower sides and upper sides, but different cone heights, and the lower sides of the two tapered holes (4) are located at two ends of the bidirectional tapered hole (41) and are mutually jointed with lower sides of the adjacent bidirectional tapered hole (41); and
the external thread (9) is formed by oppositely jointing asymmetrical upper sides of two truncated cone bodies (7), wherein the two truncated cone bodies (7) have same lower sides and upper sides, but different cone heights, and the lower sides of the two truncated cone bodies (7) are located at two ends of the bidirectional truncated cone body (71) and are mutually jointed with lower sides of the adjacent bidirectional truncated cone body (71).

7. The connection pair according to claim 1, wherein the internal thread (6) and the external thread (9) form a thread pair (10); and
a contact surface between the first helical conical surface (421) of the tapered hole and the first helical conical surface (721) of the truncated cone body in mutual fit as well as a contact surface between, the second helical conical surface (422) of the tapered hole and the second helical conical surface (722) of the truncated cone body in mutual fit are used as bearing surfaces; an outer diameter of an internal cone and an inner diameter of an external cone are centered under the guidance of the helical line till the conical surface (42) of the bidirectional tapered hole and the conical surface (72) of the bidirectional truncated cone body are cohered till the helical conical surface bears a load in one direction and/or the helical conical surface bears the load in two, directions and/or till self-positioning generated by self-positioning contact and/or interference contact.

8. The connection structure according to claim 1, wherein a screw body (31) of the columnar body (3) is provided with the dumbbell-like shaped asymmetrical bidirectional tapered external thread (9) having the left taper (95) greater than the right taper (96) and/or the dumbbell-like shaped asymmetrical bidirectional tapered external thread (9) having the left taper (95) smaller than the right taper (96);
when a connecting hole of the cylindrical body (2) is screwed into in a screw-in end of the columnar body (3), the connecting hole of the cylindrical body (2) is not allowed to be screwed in a reverse direction, the connecting hole is a threaded hole arranged on a nut (21) and a nut (22), and the connecting hole is arranged in the nut (21) and the nut (22);
the nut refers to an object comprising a nut with a thread structure on the inner surface of the cylindrical body (2); and
when a single nut and/or double nuts and/or multiple nuts of the dumbbell-like shaped asymmetrical bidirectional tapered internal thread (6) of the cylindrical body (2) is/are in mutual thread fit with the dumbbell-like shaped asymmetrical bidirectional, tapered external thread (9) of the screw body (31) of the columnar body (3) for use, the thread of the cylindrical body (2) comprises the dumbbell-like shaped asymmetrical bidirectional tapered internal thread (6) having the left taper (95) greater than the right taper (96) and/or the dumbbell-like shaped asymmetrical bidirectional tapered internal thread (6) having the left taper (95) smaller than the right taper (96).

9. The connection structure according to 8, wherein when one nut is combined with the bolt, i.e., the internal thread (6) and the external thread (9) forming the tapered thread connection pair (10) are cohered together, the other nut is capable of being removed and/or kept, the removed nut is used as an installation process nut, and an internal thread of the installation process nut comprises the bidirectional tapered thread (1), a unidirectional tapered thread and a traditional thread such as a triangular thread, a trapezoidal, thread, a sawtooth thread, a rectangular thread and an arc thread.

10. The connection structure according to claim 1, wherein the internal thread (6) and/or the external thread (9) comprises a single thread body which is an incomplete tapered geometry, that is, the single thread body is an incomplete unit thread.

11. The connection structure according to claim 1, wherein when the left taper (95) is greater than the right taper (96), the first taper angle (α1) is greater than 0° and smaller than 53°, and the second taper angle (α2) is greater than 0° and smaller than 53°; and/or, the first taper angle (α1) is greater than or equal to 53° and smaller than 180°; and
when the left taper (95) is smaller than the right taper (96), the first taper angle (α1) is greater than 0° and smaller than 53°, and the second taper angle (α2) is greater than 0° and smaller than 53°; and/or, the second taper angle (α2) is greater than or equal to 53° and smaller than 180°.
